(19) United States
(12) Patent Application Publication
(10) Pub. No.: US 2006/0145815 A1
(43) Pub. Date: Jul. 6, 2006

(54) System and method for relaying RFID data

(76) Inventors: Valerio Lanzieri, Montreal (CA); Dang Tue Hoang, Montreal (CA); The Vinh Nguyen, Montreal (CA); Koon Hung Lee, Brossard (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 11/128,218

(22) Filed: May 13, 2005

(30) Foreign Application Priority Data
Jan. 6, 2005 (CA) 2,491,608

(51) Int. Cl. H04Q 5/22

(52) U.S. Cl. 340/10.2; 340/10.1; 340/572.1; 340/10.34; 340/5.92

(57) ABSTRACT

A system and method for relaying data from tags associated with inventory items is provided. The system comprises a passive tag and a transceiver. The passive tag comprises data associated with an inventory item and a transmission module to transmit a message containing the data in an passive tag frequency. The transceiver receives the message, transfers the data into another message and transmits the other message as an active tag message. It may further comprise an active tag, an application server and an active reader. The active tag is associated with another inventory item, has data associated with it and has a transmission module to transmit an active tag message. The server stores and processes data associated with the active tag and the passive tag. The active reader receives the active tag message and communicates the active tag message to the application server.

### FIELD OF INVENTION

The present invention relates to a Radio Frequency IDentification (RFID) system, and more particularly a system and method for relaying RFID data.

### BACKGROUND

Numerous systems exist for the physical tracking of inventory, raw materials, materials, pallets, freight containers, or other items in a variety of locations, such as manufacturing facilities, warehouses, libraries, offices and the like. Accurate and inexpensive locating, tracking and inventorying of the physical location of items such as parts, goods, and materials is a necessity for many operations, such as manufacturing and warehousing, for a number of reasons. Such reasons include the desire or need to quickly determine the physical location of a part in the manufacturing process, or to determine whether a part is present in inventory or storage, to determine the quantity of an item on hand, to track the progress of an item in manufacture, and many other such functions.

Many types of inventory systems, based on various technologies, have been developed but more, and more, inventory systems are now based on the Radio Frequency IDentification (RFID) technology. A typical RFID system consists of a tag, a reader, and some sort of data processing equipment, such as a computer or application server. The reader sends a request for identification information to the tag, the tag then responds with its specific information, which the reader then forwards to the data processing device. The tag and reader communicate with one another over an RF channel. A RFID system has advantages over a bar code system such as the ability to hold more data, the ability to change the stored data as processing occurs and most importantly, does not require line-of-sight to transfer data.

EPCglobal is a standards organization which has defined some operating standards for RFIDs. In particular, under EPCglobal protocols, the following classes of RFID tags are defined:

Class 0—Passive tags

Class I—Passive read-only tags

Class II—passive tags with additional functionality like memory or encryptions.

Class III—semi-passive RFID tags. They may support broadband communication.

Class IV—active tags. They may be capable of broad band peer-to-peer communication with other active tag in the same frequency band, and with readers.

Class V—these tags are essentially readers. They may be able to power other Class I, II and IlI tags, as well as communicate with other Class IV tags and with each other wirelessly.

Generally, transmissions may use any of various frequency bands, including low-band (around 125 KHz), high-band (around 13.56 MHz) and ultra-high band frequencies (around 850-950 MHz) and microwave bands (around 2.45 GHz).

FIG. 1 shows a class 0/I passive RFID system 10. The RFID system 10 includes a passive tag reader 14, which connects to an antenna 18, to detect passive tags 12, using a standard passive frequencies 16 to activate the passive tags 12 within its operating range, and then sends the information back to an application server 2 via a communication connection 4 such as a RS232 connection. However, one drawback for RFID system 10 is that each passive tag reader 14 requires a direct connection 4 to the application server 2. In a commercial environment there are typically hundreds of shelves in multiple areas, thus the number of direct connections 4 to the application server 2 quickly becomes unmanageable.

With the explosion of the demand for RFID systems, for example in the retail market and transportation fields, more economical RFID systems are needed in order to lower the cost associated with the use of such systems. In order to reduce the number of direct connections 4, and thus reduce the associated cost, RFID systems, such as RFID system 20 shown in FIG. 2, have introduced passive tag readers 24 having multiple antennas 18. The passive tag reader 24 multiplexes antennas 18, activating each one in turn. This reduces the number of direct connections 4 and allows for more flexibility but depending on the physical layout of the premises where the RFID system 20 is put into operation, multiple application servers 2 may be required because direct connections 4 are not practical. A RFID system having multiple antenna passive tag readers is disclosed in U.S. Pat. Ser. No. 6,714,121.

In order to extend the distance between the tags and the readers, RFID systems, such as RFID system 30 shown in FIG. 3, have introduced active tags 32. By extending the distance between the tags 32 and the readers 34, which is usually in the tens of meters, antennas local to the tags 32 are no longer required, thus further reducing the number of required readers 34. This also allows for more flexibility in the positioning of the readers 34, making the need for multiple application servers 2 less likely. The RFID system 30 includes an active tag reader 34, which receives information sent by the active tags 34 using a standard class IV frequency 6, and then sends the information back to the application server 2 via a standard connection 4 such as a RS232 connection. However, although the RFID system 30 alleviates some of the disadvantages of RFID systems 10 and 20, active tags 32 are costlier than passive tags 12 and active tag readers 34 still require direct connections to the application server 2.

Accordingly, there is a need for a system and method for providing remote access to applications and data which addresses deficiencies in the prior art.

### SUMMARY

In a first aspect, a system for relaying data from tags associated with inventory items is provided. The system comprises a passive tag and a transceiver. The passive tag comprises data associated with an inventory item and a transmission module to transmit a message containing the data in a passive tag frequency. The transceiver receives the message, transfers the data into another message and transmits the other message as an active tag message.

The system may further comprise an active tag, an application server and an active reader. The active tag is associated with another inventory item, has data associated with it and has a transmission module to transmit an active tag message. The server stores and processes data associated with the active tag and the passive tag. The active reader receives the active tag message and communicates the active tag message to the application server.

In the system, the transceiver may periodically send request messages to identify neighbouring transceivers, tags and active readers.

In the system, if the transceiver cannot contact the active reader, the transceiver may attempt to identify a neighbouring transceiver having contact with the active reader and then transmit the second message to the neighbouring transceiver.

In the system, the second message may be a request to the neighbouring transceiver to forward the second message to the active reader.

In the system, the transceiver may store the data in a buffer and may periodically transmit the data relating to received messages as active tag messages.

In the system, the transceiver may comprise a transmitter for the active tag messages; a transmitter for passive tag messages; a microprocessor; the buffer; and a program operating on the microprocessor to control generation and transmission of transmitted messages and receipt and analysis of received messages.

In a second aspect, a method for relaying data from tags associated with inventory items is provided. The method comprises: at a transceiver, receiving a message in a passive tag frequency from a passive tag containing data associated with an inventory item; and at the transceiver transferring the data into a second message and transmitting the second message as an active tag message.

For the transceiver, the method may further comprise storing the data; periodically transferring the data into a second message; and transmitting the second message to as an active tag message.

In the method, if the transceiver cannot contact the active reader, attempting to identify a neighbouring transceiver having contact with the active reader and then transmitting the second message to the neighbouring transceiver.

The method may further comprise requesting that the neighbouring transceiver to forward the second message to the active reader.

In a third aspect, a system for tracking tags associated with inventory items is provided. The system comprises: a collection of active tags, a collection of passive tags, a network of transceivers, an application server and an active reader. Each active tag is associated with an inventory item and comprises data associated with the inventory item and a first transmission module to transmit a first message. Each passive tag is associated with another inventory item and comprising data associated with that item and a second transmission module to transmit a second message. The network of transceivers reads passive tag messages from any passive tag in its communication range and broadcasts transceiver messages containing data from the passive tag messages to the active reader. The server stores and processes data associated with the active and passive tags. The active reader receives any of the first and transceiver messages, extracts encoded data therefrom and provides the encoded data to the application server.

In the system, transceivers may store data contained in received passive tag messages before broadcasting transceiver messages.

In the system, the neighbouring transceiver may provide an acknowledgement message to the transceiver upon receipt of the any transceiver messages; and the transceiver may clear its buffer of any data related to the any transceiver messages upon receipt of the acknowledgement signal.

The system may further comprise a second active reader which operates in a similar manner to the other active reader. Also, the active readers may each periodically check whether it can contact the application server and if it cannot, then it may attempt to contact the other active reader to transmit any encoded data to the application server.

In other aspects various combinations of sets and subsets of the above aspects are provided.

### BRIEF DESCRIPTION OF THE FIGURES

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIGS. 1-3 are block diagrams each showing a prior art RFID system;

FIG. 4 is a block diagram showing a RFID system associated with an embodiment of the invention;

FIG. 5 is a block diagram showing a transceiver of the RFID system of FIG. 4;

FIG. 6 is a block diagram showing a first part of a RFID system of the RFID system of FIG. 4;

FIG. 7 is a block diagram showing an active reader of the RFID system of FIG. 4;

FIG. 8 is a block diagram showing a second part of a RFID system of the RFID system of FIG. 4;

FIG. 9 is a flow chart showing operation an active reader of the RFID system of FIG. 4; and

FIG. 10 is a flow chart showing operation an transceiver of the RFID system of FIG. 4.

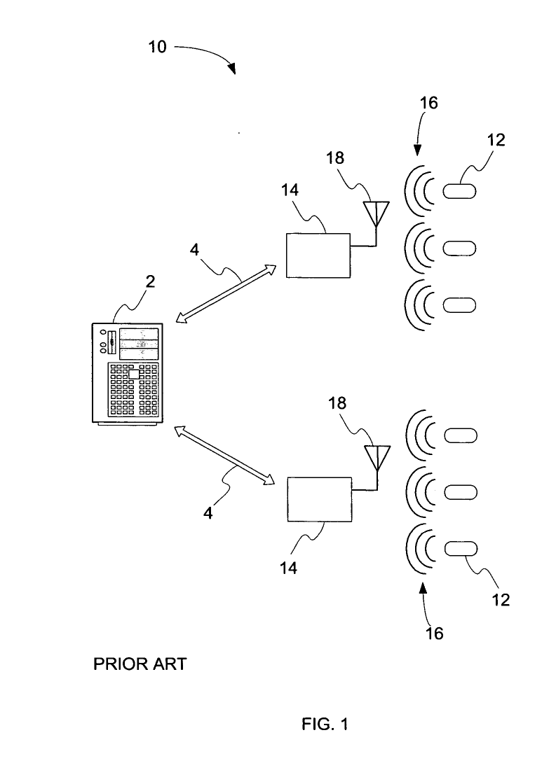

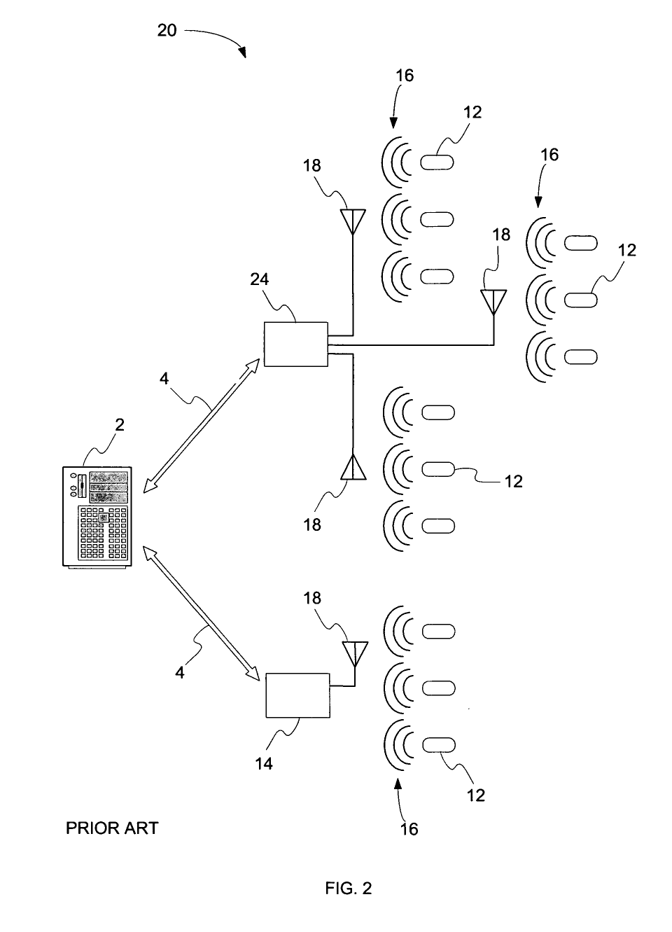

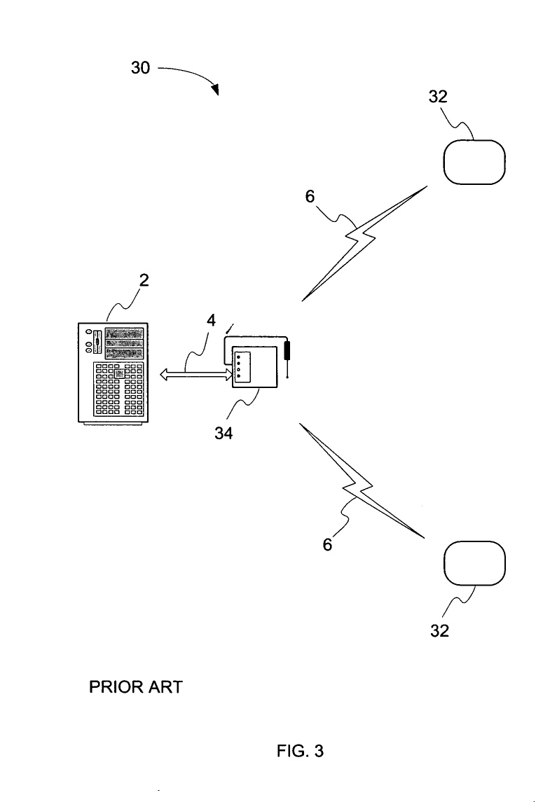

### DETAILED DESCRIPTION

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

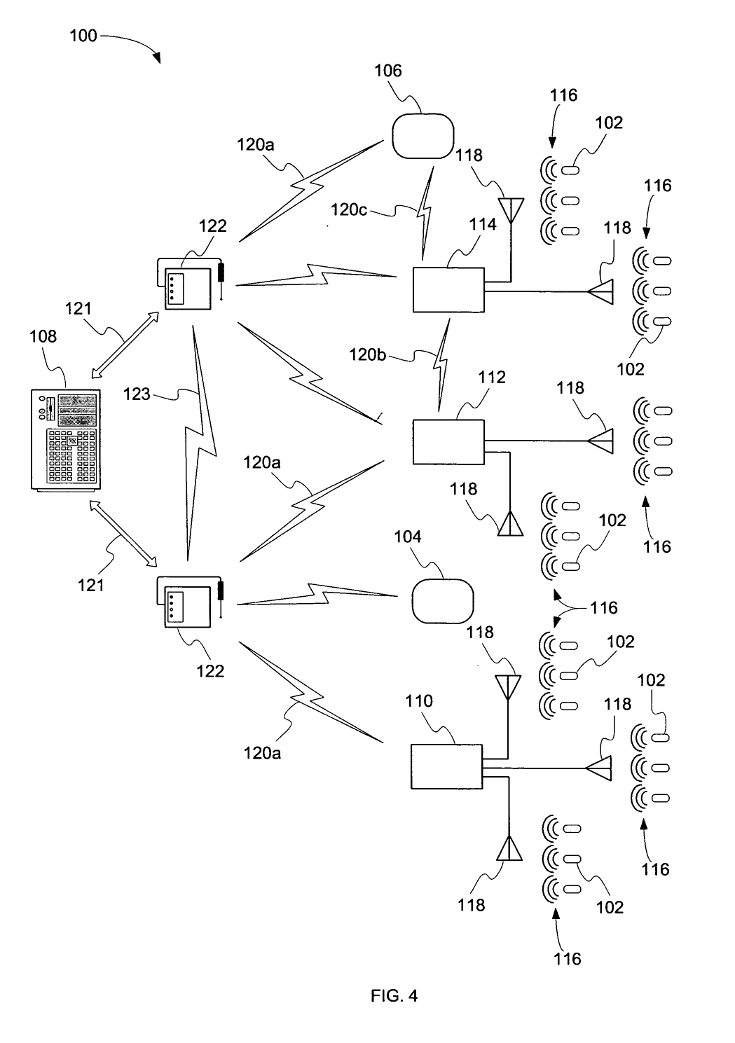

Referring to FIG. 4, RFID system 100 is shown. System 100 provides a network of components in communication with each other to provide data relating to inventory items to a server at a central location. System 100 includes a collection of passive tags 102, a collection of active tags 104 and 106, transceivers 110, 112, 114, active reader 122 and server 108 running application software. A brief description is provided on the components of system 100.

Server 108 is a computer operating the application software. The software tracks and catalogs data provided to it which originates, ultimately, from either passive tags 102 or active tags 104 and 106.

Passive tags 102 and active tags 104 and 106 are each typically physically associated with an inventory item (not shown). Each tag is encoded with data, such as, for example, serial ID numbers, quantity counts and other data relating to the item. Also, the tag may be encoded with dynamic data relating to a feature relating to the item (e.g. dynamic temperature readings, pressure readings, digitized voice, video, pictures etc.). Once activated, the tags generate a wireless signal which is broadcast from its antenna to the airspace.

In particular, passive tags 102 are unpowered devices which generally require activation and power extracted from an external RF signal. Each passive tag has a data module which stores the data associated with the inventory item and a communication module which receives signals from outside sources (such as a transceiver) and generates and transmits messages to outside recipients (such as a transceiver or active reader). Generally, passive tags 102 transmit messages in a range of passive tag frequencies. One exemplary frequency used for passive tag messages is 13.56 MHz. For the embodiment, the passive tag frequencies are in a lower frequency band than transmission frequencies used for active tags; however, in other embodiments, the selection of frequencies for both active and passive tags may change. For the purpose of this description, semi-passive tags are grouped with passive tags, unless noted.

Active tags 104 and 106 are self-powered and do not require an external power source (as opposed to passive tags) to activate their circuits. Each active tag has a power module, a data module which stores the data associated with the inventory item and a communication module which receives messages from outside sources (such as a transceiver) and generates and transmits messages to outside recipients (such as a transceiver or active reader). In an embodiment, messages for an active tag are generally encoded in active tag frequencies. One exemplary frequency used for active tag messages is 434 MHz. The broadcast range of messages encoded in active tag frequencies is generally larger than that of a passive tag because use of a higher frequency generally increases broadcast range and because the active tags have sufficient power to generate stronger transmissions than comparable transmissions from passive tags.

In order to provide the data in the passive tags to server 108, transceivers 110, 112 and 114 send messages to the tags, receive responses from them and forward data from the tags to an active reader, which then forwards the data to the server 108. Meanwhile active tags communicate directly with an active reader. Collectively, the transceivers and active readers are placed in various regions around the server 108 and define a network that can forward any received data from the tags to the active reader(s) or can forward any data to other transceivers in the network, if the active reader cannot be contacted or if the buffer in the active reader or transceiver is full or if a certain time period has passed (e.g. 2 minutes, 10 minutes or any predefined time period). It will be appreciated that other events or conditions may be used as a trigger to send data from the transceivers to the active readers. As the broadcast range of messages from active tags is generally quite large, it is common that an active tag can transmit its data directly to active reader 122.

The system provides communication amongst components in the system through the exchange of messages. Active components in the system (e.g. transceivers and active readers) can query a neighboring component to relay data to another component. For example, an active reader can ask a neighbouring reader to relay its data to the application server. Similarly, a transceiver can ask a neighbouring transceiver to relay its stored data to an active reader or the application server. Each component has unique ID codes which are included in the transmitted messages. This helps to avoid having many neighboring components relaying the same message to the server or an active reader. Preferably, an acknowledgement message is sent from the receiving component to the requesting component when a relay message is received. Upon receiving the acknowledgement message, the requesting component can clear its buffer of the data associated with the relay message.

Further detail is now provided in turn on the transceiver and then on active readers in network 10.

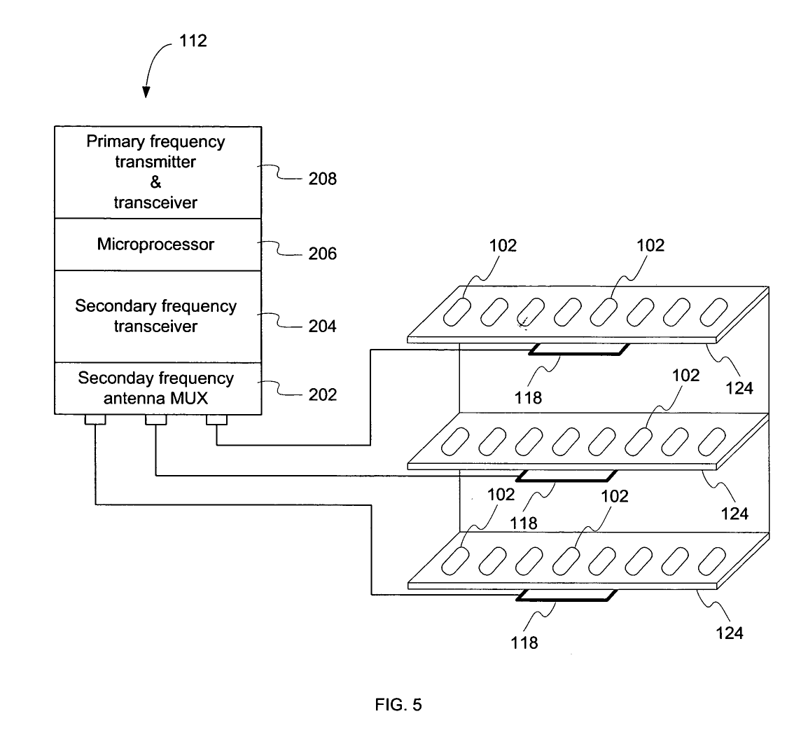

Referring to FIG. 5, transceiver 112 is shown which has exemplary structure, description and functionality found also in transceivers 110 and 114. A transceiver may also be called a transformer or any other term known in the art. Transceiver 112 has a first series of modules for processing passive tag messages and a second series of modules for processing active tag messages. For the active tag messages, a primary frequency transmitter 208 is provided for active frequency communication. For the passive tag messages, the first module comprises one or more antennae 118, a secondary frequency antenna MUX 202 and a secondary frequency transceiver 204 to form a passive frequency reader. Each antennae can transmit and receive wireless signals unless otherwise noted. Generally, transceiver 112 may be powered using batteries or through a connection to an external power source. A microprocessor 206 and its firmware/software controls all operation of transceiver 112. A buffer (not shown) is provided to store data which is received from the tags. Part of the buffer is also used to maintain databases relating to ID information relating to transceivers, active readers and tags known to the particular transceiver. The software can routinely clear part or all of the buffer.

Transceiver 112 can activate passive tags by selectively emitting an activation field 116 designed to trigger and activate passive tags through antennae 118. Upon receipt of the activation field 116 from a transceiver, a passive tag 102 converts the message in the field to a power signal and a content message. The tag analyzes utilizes the power signal to provide power to the electrical circuit of the tag. Once powered, the circuit analyzes the content message and selectively generates a responding message for transmission through its antenna.

Transceiver 112 is also used to transmit data from passive tags 102 within their range to active reader 122 through wireless connections 120a using active tag frequencies. It is notable that prior art RFID systems use passive tag readers connected only directly to their application server. Transceiver 112 uses primary frequency transmitter 208 to transmit and receive wireless messages from other transceivers 110, 112 and 144, any tags and active reader 122. Preferably, the primary transmitter 208 utilizes frequencies in the active tag frequency range for its messages. It will be appreciated that use of an active frequency signal to transmit passive tag data reduces the number of transceivers and application servers required, per existing passive tag network topologies.

A transceiver may operate in a fully active mode, a sleep mode, trigger mode and a fully off mode. In the fully active mode, the transceiver has all components powered and active. In the trigger mode, the transceiver remains in a low power mode and waits for a predetermined event to occur. Such events include waiting until: a physical movement of the transceiver (e.g. through an accelerometer) is detected; or receipt of a beacon message to wake up. In the sleep mode, the transceiver remains in a lower power mode until a predefined timer has expired or a predefined event occurs. After the transceiver is awakened after the sleep mode, it can send messages to the active reader. All other messages would be ignored until the transceiver is caused to be awakened. Other modes may also be provided in other embodiments.

When first activated, transceiver 112 determines what devices with which it can communicate. As such, it scans for tags, transceivers and readers located within in its broadcast range.

To check for passive tags, microprocessor 206 generates a poll message which is broadcast from transceiver 204. When passive tags in the broadcast range of transceiver 204 receive the poll message, they each separately generate and transmit a response message which provides their tag data to transceiver 112. The response messages are encoded in passive tags frequency signals which can be received by frequency transceiver 204. All received response messages are analyzed by microprocessor 206 for the tag data of detected passive tags. A timeout routine provides a limit for waiting for responses from any passive tags. If there is collision of data when detecting passive tags, a collision resolution technique may be used, such as those provided in the ISO standard known to those skilled in the art. After microprocessor 206 analyzes the data, a further message is generated by microprocessor 206 to send the data to active reader 122. The data may be forwarded directly after receiving the response or the data. This further message is sent using the primary frequency transmitter 208 for it to transmit to the active reader 122, typically using active frequencies transmitted through wireless connection 120a.

Alternatively, instead of processing and forwarding each response message as it is received, the data from the response messages may be stored collectively in the buffer. Periodically, and before the buffer is completely filled, one transmission providing the data of all the IDs stored in the buffer may be provided to the active reader 122. In the embodiment, the transfer of data is be done in sequential individual transfers of data from individual tags. In another embodiment, the transfer of data in the buffer may be done in bulk in one message with one bulk attachment of data.

After the information is sent to active reader 122, microprocessor 206 then can repeat the cycle by sending a message to the secondary frequency transceiver 204 instructing it to poll for any additional passive tags 102. Microprocessor 206 also controls the secondary frequency antenna MUX 202 so that only one of the antennas will connect to the secondary frequency transceiver 204 at a given instant.

On a transceiver's activation, its buffer may already be prepopulated with data regarding its neighbouring transceivers. Therein, each neighbouring transceiver may have an entry in the buffer providing a unique ID associated for it and a code indicating whether it can communicate with an active reader. Alternatively, the transceiver may check for neighbouring transceivers in its broadcast range during its operation. While such a check may be done at any time, it will be appreciated that it may not be necessary to check for neighbouring transceivers until either the transceiver determines that it cannot establish communication with an active reader or if the buffer of the transceiver is full.

When a transceiver initiates a check for neighbouring transceivers, the embodiment performs the following steps. First, using the data in the buffer, transceiver 112 checks the status of any currently known neighbouring transceiver by requesting a status check from each known neighbouring transceiver. For example, in the buffer, the database contains an indexed list of known neighbouring transceivers. For example, the neighbours may be sequentially tracked using an index beginning with 000. Each known neighbouring transceiver is sent a status query, in sequence. If the transceiver receives a valid response from the known neighbouring transceiver, it registers that transceiver into its database.

If the transceiver receives an invalid response or no response, this indicates that a request collision has occurred and that the noted neighbouring transceiver cannot be contacted. As such, the transceiver checks the next known neighbouring transceiver in its buffer, e.g. the neighbour associated with index 001. The transceiver will then send a message to the neighbour transceiver identified as 001 to determine whether it has a connection to an active reader 122. If the neighbouring transceiver has a connection with active reader, the neighbour transceiver responds will an affirmative response message. Upon receipt of the affirmative response, the neighbouring transceiver requests that the transceiver sends the buffer data to the neighbouring transceiver for forwarding to the active reader. Otherwise, if the neighbouring transceiver has no connection to an active reader, the neighbouring transceiver responds that it has no active reader connection.

Next, the transceiver checks for the presence of an active reader 122 in its broadcast range. To acquire this information, the transceiver sends a broadcast message requesting that any active reader 122 respond to it. Any active reader 122 which receives this message responds to the message with a reply which gives identification details relating to the active reader 122.

It will be appreciated that in other embodiments, the process of checking for neighbouring tags, readers and transceivers may be done in any order and at any time.

In other embodiments, a transceiver may be provided with additional circuitry, transmission elements and software to communicate with active tags, using similar components provided in active tags, described below.

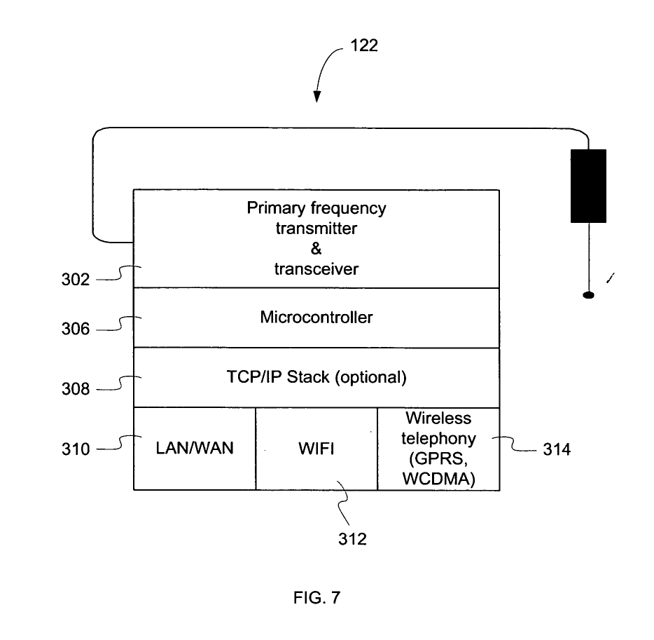

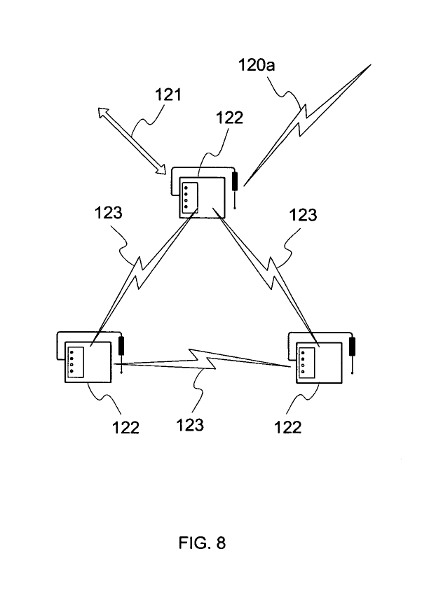

Per FIG. 7, further detail is now provided on active reader 122. Active reader 122 has primary transceiver 302 and secondary transceiver 304, a microprocessor 306, and optional TCP/IP stack 308. A transmitting technology is also provided and preferably is a wireless technology, such as one of: LAN/WAN 310, WIFI 312 and wireless telephony backbone 314 (utilizing any wireless protocol, such as GPRS, CDMA, variants thereon and others).

When an active reader 122 is activated, software operating thereon checks for the presence of any transceivers 110, 112 or 114, tags 104 or 106. This is accomplished by generating a broadcast query message which is converted to a wireless signal and is sent via primary frequency transmitter 302 for broadcast through its broadcast range. Any transceivers 110, 112, 114 and active tags 104, 106 in the broadcast range receives the query message and its software operating thereon is programmed to generate a response message, which is sent through its antenna to its local broadcast range. At active reader 122, primary frequency transceiver 302 will then check for the presence any response message from any of transceivers 110, 112, 114 and active tags 104, 106. If there is no response, the active reader will keep sending the message until there is a response from either a transceiver or an active tag. The active reader may also send a broadcast request message that any transceiver or active tag also report its ID and data to the active reader.

Upon receiving a message from an active reader 122, the corresponding transceivers 110, 112, 114 or active tags 104, 106 will return its information to the primary frequency transceiver 302. The transceivers and tags recognize messages as originating from an active reader 122 by examining the “type” field in the message. If the message is recognized as originating from an active reader 122, then the ID of the active reader, which is also provided in the message, is stored by the transceiver or active tag. Further details on the messages are provided below. If no message or an invalid message is received by active reader 122, it indicates that there may have been a collision of messages from two or more transceivers or tags. As such, to resolve the collisions, active reader begins to sequentially and individually poll transceivers 110, 112 and 114 and tags 104 and 106 having previously specified ID tags for any response. Preferably, the transceivers and tags do not need to know if a collision occurs with the active reader. Any such collisions are resolved by the active reader.

If active reader 122 receives no message from any transceiver/active tag, it may continue to send a check transceiver/active tag message until there is a response. In one embodiment, the active reader 122 may time out if no response is received.

Once active reader 122 has knowledge of its neighbouring transceivers and active tags in its database, active reader 122 can send a request message to each transceiver/active tag in its database to transmit the tag data to it. Each request may be sent according to a schedule. If active reader 122 does not receive a valid response before timeout period, it can request each transceiver and tag for its data, up to a predefined limit of tries, e.g. 10 tries. After the limit is exceeded, active reader 122 considers the transceiver/active tag is out of its range and removes it from its database for future requests.

When communicating with another active reader, if the active reader has not established any communication with a host computer, it will broadcast a request message to its nearby active reader to determine whether it has any connection to a host. If the nearby active reader has a connection with a host, the another active reader requests that the original active reader to send data to it so that the another active reader can relay the data back to the host. Otherwise, if the another active reader has no connection to a host, it responds to the active reader that it has no host connection.

Further detail is now provided on the protocol, syntax and contents of messages, commands and responses generated and sent by components in the system. For the sake of brevity, the term “messages” includes messages, commands, queries, signals, responses and any other data content transmitted between devices in the system, unless otherwise noted. Messages are provided as bitstreams of data, which are converted into wireless signals. For a given message, its representative bitstream is sectioned into a frame. To simplify operation and parsing of the messages, each frame is a standard length, with preset sections. One section provides an originator-type code to identify the sender (e.g. 0000 identifies the sender as a reader; 0001 identifies it as a transceiver; 0010 identifies it as an active tag.) Upon reception of a message, the receiving component analyzes the originator-type code and performs an appropriate action based on the command. A second section of the frame provides the specific command associated with the message. Commands are comprised of op codes and data. Op codes (operation codes) define the machine-level equivalent of the command instruction. It will be appreciated that other formats may be used for the messages.

The following Table 1 provides exemplary messages which are generated and sent by active reader 122. For human readability, the description field in Table 1 provides a description of the actual message. The parameter field provided therein provides information relating to the message, but it is not used for processing or transmission of the message. The data field contains any necessary data related to the message. As noted, each message is converted to an equivalent wireless signal by its transceivers 302 and 304.

TABLE 1

| Op Code | Description | Parameters | Data |
|---|---|---|---|
| 0 | Passive RFID commands (to a | Reader ID | 256 bits |
| | transceiver) | Transceiver ID | 256 bits |
| | | Length | Number of octets followed (10 bits) |
| | | Original octets | Data relayed to the passive reader |
| 1 | Request active tag ID (all) | Reader ID | 256 bits |
| 2 | Request passive tag ID (all) | Reader ID | 256 bits (all passive reader scans |
| | | | and report) |
| 3 | Order a tag to reply its data | Active reader ID | 256 bits |
| | | Target active tag | 256 bits |
| | | ID | |
| 4 | Passive RFID commands (all | Reader ID | 256 bits |
| | transceiver) | Length | Number of octets followed (10 bits) |
| | | Original octets | Data relayed to passive reader |
| 5 | Broadcast its reader ID to units | Reader ID | 256 bits |
| | with in radio range (availability | | |
| | of the reader) | | |
| 128 | Request all data (all) | [Reader ID] | Reader ID is optional. This is for |
| | | | former tags to report all data in its |
| | | | proprietary formats, e.g. tag ID, |
| | | | sensor, weight. |
| 129 | Request pressure from an | Active reader ID | 256 bits |
| | active unit | Target ID | 256 bits |
| 130 | Request temperature from an | Active reader ID | 256 bits |
| | active unit | Target ID | 256 bits |
| 131 | Request all units in listen | Reader ID | 256 bits (no response expected) |
| | mode | | |
| 132 | Request all units in sleep | Reader ID | 256 bits (no response expected) |
| | mode | Time in minutes | 16 bits |
| 133 | Receive relay data of an active | Transmitted unit | 256 bits |
| | tag which is out of range | ID | |
| | | Originated tag ID | 256 bits |
| | | Length | Number of octets followed (10 bits) |
| | | Original octets | Data relayed to an active reader |
| | | [Target reader ID] | 256 bits |
| 134 | Receive relay data from an | Transmitted unit | 256 bits |
| | active transceiver which is out | ID | |
| | of range | Orig transceiver | 256 bits |
| | | ID | |
| | | Length | Number of octets followed (10 bits) |
| | | Original octets | Data relayed to an active reader |
| | | [Target reader ID] | 256 bits |
| 136 | Request send to an adjacent | Unit ID | 256 bits |
| | reader to relay data to a host | [Target ID] | 256 bits |
| | computer | Length | Number of octets followed (10 bits) |
| | | Original octets | Data relayed to a host computer |
| 137 | Request pressure from all units | [Active reader ID] | 256 bits |
| 138 | Request temperature from all | [Active reader ID] | 256 bits |
| | units | | |
| 142 | Wake up all units | Reader ID | 256 bits (no response expected) |
| 143 | Request active transceiver ID | Reader ID | 256 bits |
| | (all) | | |
| 192 | Order tags and transceivers to | Active reader ID | 256 bits |
| | reply its data (most significant | Request active | Up to 256 bits (most significant bits) |
| | bits) | unit ID | |
| 195 | Order neighboring readers to | Active reader ID | 256 bits |
| | reply its data (most significant | Request active | Up to 256 bits (most significant bits) |
| | bits) | unit ID | |
| 196 | Reply unit ID (reader) to the | Active unit ID | 256 bits |
| | originated reader (response to | Originated reader | 256 bits |
| | op code 195) | ID | |

When primary frequency transceiver 302 receives a response message from transceivers 110, 112, 114 and active tags 104, 106 within its reading range, the software on microcontroller 306 then analyzes the received data and sends the results to the application server 108 through connections 121 using the optional TCP/IP stack 308 and any of the three types of data transmission technologies 310, 312, 314. Of course, other suitable transmission technologies and protocols may be used to transmit results from the active reader 122 to the application server 108.

When a new transceiver or active tag is activated and it detects a message from an active reader 122, it sends a request to talk to the active reader. Preferably, otherwise, it does not send any request to the active reader. Upon receiving permission from an active reader to talk, the transceiver/active tag responds with its ID and registers the active reader's ID into its memory. After registering with the active reader, the transceiver/active tag waits for a request from the active reader to report its data. If the transceiver/active tag does not receive any signal from an active reader before a timeout, it will then send a request to talk. Thereafter, if no response is received, it will assume that active reader is out of its range. Subsequently, it will monitor for messages from other active readers.

Further detail is now provided on transceiver 112. When transceiver 112 detects another transceiver in its broadcast range, it can selectively provide its data relating to its known tags to the other transceiver. In particular, as noted earlier, when the data buffer in the transceiver is full and it has not established any communication with an active reader, it may check for the presence of any neighbouring transceiver. This may be accomplished by requesting any neighbouring transceiver to respond. It may simply select a transceiver from a database of known transceivers and sequentially poll each transceiver. If the transceiver receives a valid response from a transceiver, it will register that transceiver into its database. If the transceiver receives an invalid response, it means that collision has occurred. As such, collision detection and recovery protocols, as described earlier, may be employed.

Next, upon determining its neighbours, the transceiver sends a message to its neighbouring transceivers to determine whether they have any connection to any active reader 122. If the neighbouring transceiver has a connection with an active reader, it will request the original transceiver to send data to it so that the neighbouring transceiver can relay the data back to the active reader. Otherwise, if the neighbouring transceiver has no connection to an active reader, it responds to the original transceiver indicating that it has no connection to the active reader.

Generally, the program performs analysis on the data received from the secondary frequency transceiver 204. For example, the program can determine the number of passive tags 102 detected and send forward that information in a message intended for application server 108.

The following Table 2 provides exemplary messages and responses which are generated and sent by transceivers 110, 12 and 114. The messages in Table 2 follow a similar structure as those messages described for Table 1.

TABLE 2

| Op Code | Description | Parameters | Data |
|---|---|---|---|
| 0 | Passive RFID response | Transceiver ID | 256 bits |
| | | Length | Number of octets followed (10 bits) |
| | | Original octets | Data relayed to host computer |
| | | [Originated reader ID] | 256 bits |
| 1 | Report active tag ID | Active tag ID | 256 bits |
| | | [Originated reader ID] | 256 bits |
| 2 | Report passive tag ID | Active unit ID | 256 bits |
| | | No. of passive tag ID | 8 bits (255 tag IDs) |
| | | Passive tag ID | 256 bits |
| | | [Passive tag ID] | 256 bits |
| | | [Originated reader ID] | 256 bits |
| 3 | Tag returns its ID | Request active tag ID | 256 bits |
| | | Originated reader ID | 256 bits |
| 4 | Passive RFID response | Transceiver ID | 256 bits |
| | | Length | Number of octets followed (10 bits) |
| | | Original octets | Data relayed to host computer |
| | | [Originated reader ID] | 256 bits |
| 128 | Report all data | Active Unit ID | This is for former tags to report all |
| | | | data in its proprietary formats, e.g. |
| | | | tag ID, sensor, weight. |
| | | Length | Number of octets followed (10 bits) |
| | | Original octets | Data relayed to host computer |
| | | [Originated reader ID] | 256 bits |
| 129 | Report pressure | Active Unit ID | 256 bits |
| | | Pressure in KPa | 256 bits |
| | | [Originated reader ID] | 256 bits |
| 130 | Report temperature | Active Unit ID | 256 bits |
| | | Temperature in | 256 bits |
| | | Celsius | |
| | | [Originated reader ID] | 256 bits |
| 133 | Relay info from another | Transmitted unit ID | 256 bits |
| | active tag which is out of | Originated tag ID | 256 bits |
| | communication range | Length | Number of octets followed (10 bits) |
| | | Original octets | Data relayed to host computer |
| | | [Target reader ID] | 256 bits |
| 134 | Relay info from another | Transmitted | 256 bits |
| | active transceiver which is | transceiver ID | |
| | out of communication range | Originated transceiver | 256 bits |
| | | ID | |
| | | Length | Number of octets followed (10 bits) |
| | | Original octets | Data relayed to host computer |
| | | [Target reader ID] | 256 bits |
| 135 | Request a transceiver to | Unit ID | 256 bits |
| | relay data to a reader with | [Target ID] | 256 bits |
| | data | Length | Number of octets followed (10 bits) |
| | | Original octets | Data relayed to host computer |
| 137 | Report pressure | Unit ID | 256 bits |
| | | Pressure in KPa | 256 bits |
| 138 | Report temperature | Unit ID | 256 bits |
| | | Temperature in | 256 bits |
| | | Celsius | |
| 139 | Acknowledgement to order | Unit ID | 256 bits |
| | to relay data in response to | Target ID | 256 bits |
| | op code 135 | Answer code | 1 bit (successful or not) |
| 140 | Request to relay data to a | Unit ID | 256 bits |
| | reader | Target ID | 256 bits |
| 141 | Acknowledgement to op | Unit ID | 256 bits |
| | code 140 | Target ID | 256 bits |
| | | Answer code | 1 bit (reader available or not) |
| 143 | Report transceiver ID | Unit ID | 256 bits |
| | | [Originated reader ID] | 256 bits |
| 192 | Reply unit ID (tag or | Active unit ID | 256 bits |
| | transceiver) to the reader | Active reader ID | 256 bits |
| 193 | Order neighboring | Transceiver ID | 256 bits |
| | transceivers to reply its data | Request active unit ID | Up to 256 bits (most significant |
| | (ID) (most significant bits) | | bits) |
| 194 | Reply unit ID (transceiver) to | Active unit ID | 256 bits |
| | the originated transceiver. | Originated transceiver | 256 bits |
| | Response to op code 193. | ID | |

It will be appreciated that other messages may be provided and that the size and content of the data fields of the commands may be amended for different installation requirements. It will further be appreciated that these messages may also be generated by active tags, where appropriate.

The transceiver 112 may connect to multiple antennae 118 through its secondary frequency antenna MUX 202. The program operating on microprocessor 206 controls the antenna switching circuit of the secondary frequency antenna MUX 202 so that only the needed antennae 118 connects to the secondary frequency transceiver 204 at any given time.

As noted earlier, primary frequency transmitter 208, in addition to transmitting information to the active reader 122 using active frequencies through wireless connection 120a, acts as a relay for another transceiver 110, 114. Thus, any of the transceivers 110, 112, 114 may serve as a repeater in order to relay information from any of the transceivers 110, 112, 114 or active tags 104, 106 to the active reader 122. As noted earlier, in another embodiment, the transceiver can communicate with an active tag 104, 106.

For example, referring back to FIG. 4, if the top active reader 122 was out of service, having for consequence that transceiver 114 is out of range of the remaining active reader 122, transceiver 112 would then receive the transmission 120b from transceiver 114 and relay it to the remaining active reader 122 along with its own transmission 120a.

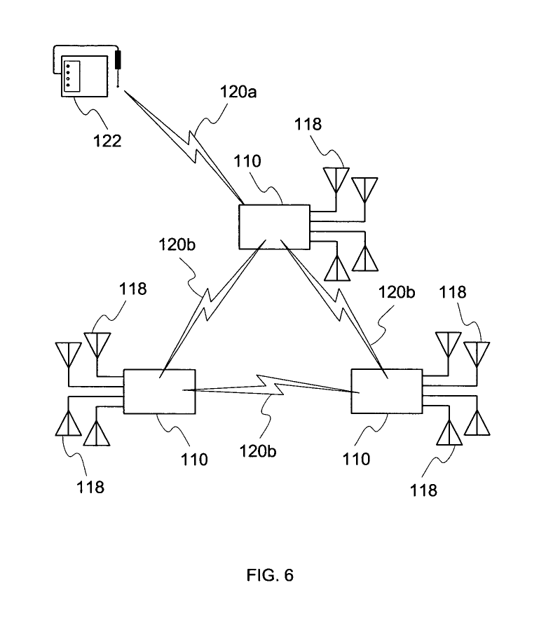

The primary frequency transmitter 208 is also used for bi-directional communications between transceivers 110 as shown in FIG. 6. Communications include notifying the surrounding transceivers 110 of its presence and relaying information from other transceivers 110 to the active reader 122 as discussed above.

The active readers 122 receive the transmissions 120a transmitted by both the transceivers 110, 112, 114 and active tags 104, 106, and forward the received information to the application server 108 through connections 121.

In addition, the transceiver 112 contains circuitry so that it may be reconfigured to perform different functionalities, such as reporting temperature or pressuring readings. It will be appreciated that in another embodiment, the program on transceiver 112 may be downloaded thereto using a connector, for example a DB15 connector, to download new code from a computer or other data processing equipment such as a personal digital assistant.

In addition, the primary frequency transmitter 302 may send a signal to control a specific or all transceivers 110, 112, 114 or active tags 104, 106 within its reading range.

Apart from sending messages to the transceivers 110, 112, 114 or active tags 104, 106, the active reader 122 may also rank the transceivers 110, 112, 114 according to the number of passive tags 102 each has detected. The transceivers 110, 112, 114 detecting the most passive tags 102 having a higher priority than the others and thus receiving a message to report back to the active reader 122 more often.

Also, as noted earlier, if the data buffer in an active reader 122 is full and if it has not established any communication with the server, it will broadcast a message to its neighbouring active reader to determine whether the neighbouring reader has any connection to a host.

Further referring to FIG. 5, the antennas 118 may be part of a “smart shelf” that enable retailers to perform real-time inventories of items stored on their shelves 124. An antenna 118 is attached underneath each of the shelves 124, which in theory should be shielded by a metal plane so that the passive tags 102 of the items stored on a particular shelf 124 may only be read by the antenna 118 attached to it. However, one way of insuring that an antenna 118 only reads the passive tags 102 located on the shelf it is attached to, is to ensure that the separation in between each shelf 124 is greater than the reading range of the antenna 118.

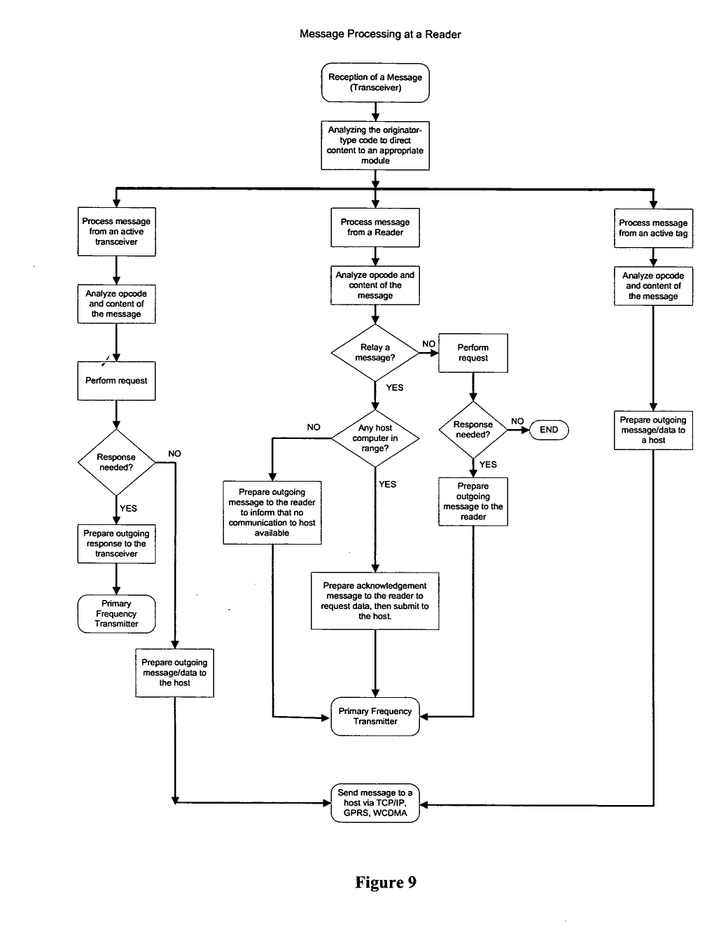

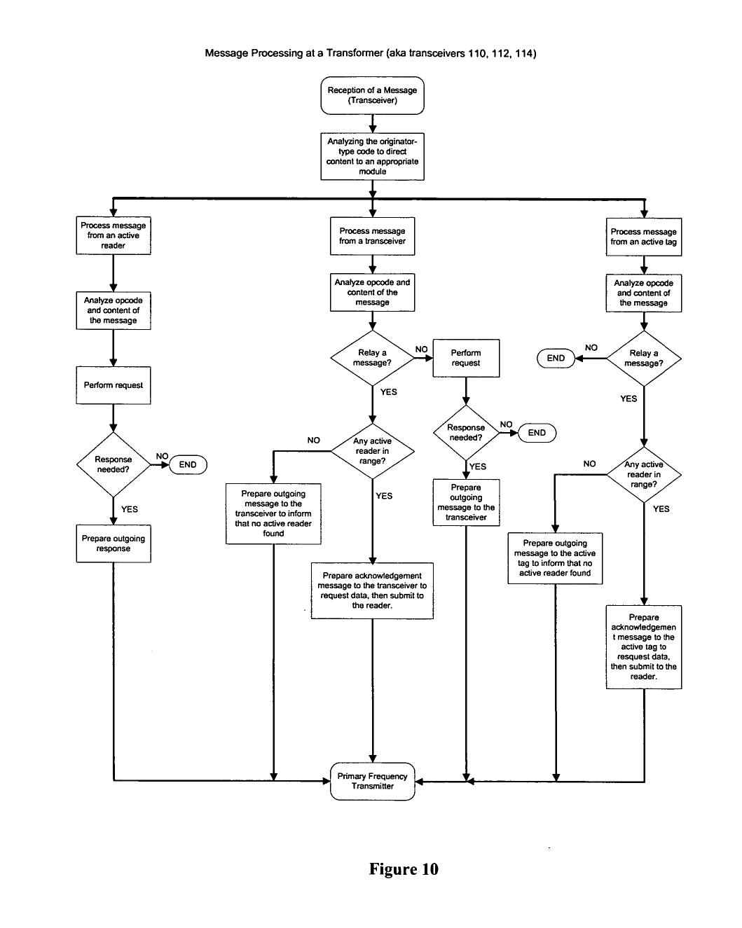

Referring to FIG. 9, further detail is provided on flow of messages and responses with an active reader. Specifically, after an active reader receives a message, it analyzes the orginating-type code to determine whether the message came from: (i) a transceiver (identified as an active transformer in FIG. 10); (ii) another active reader; or (iii) an active tag. Again, the source of the message dictates a path of procedures taken by the transceiver. Other types of messages may be processed in other methods, not shown in FIG. 9.

If the message is from a transceiver, the following steps are performed. First, the message is analyzed for its op code and content and the request is executed. If a response is required, then a response message is generated and sent through the primary frequency transmitter. In any event, the data from the message is prepared for transmission to the server through an appropriate medium. In other embodiments, a command may also require that the active reader generate and transmit a message to the server.

If the message was from an active reader the following steps are performed. First the message is analyzed for its op code and content. If there is a request in the message, it is performed. If the message is a request to relay a message, then the active reader checks to see if it has a connection to the server. If it does not have a connection, then it prepares and sends a message to the requesting reader that it has no connection to a server. If it has a connection, it sends an acknowledgement message to the requesting reader through the primary transceiver and also prepares and sends a message to the server containing the data. If the message is not related to relaying data, the request in the message is performed and if any response needs to be sent to the requesting active reader, it is generated and sent through the primary transmitter.

Finally, if the message was from an active tag, the message is analyzed for its op code and content and prepares and sends a message to the server containing the data.

It will be appreciated that in other embodiments, a message may be defined which requires that when that message is received by the active reader from another active reader, a transceiver or an active tag, additional messages may be sent to other components (e.g. transceivers, active tags or other active readers) in addition to, or instead of, the messages shown in the respective branches of FIG. 9.

Referring to FIG. 10, further detail is provided on flow of messages and responses with a transceiver 110. Specifically, after a transceiver receives a message, it analyzes the orginating-type code to determine whether the message came from: (i) an active reader; or (ii) another transceiver. In another embodiment, the transceiver may also check whether the message was received from an active tag. The source of the message dictates a path of procedures taken by the transceiver. Other types of messages may be processed in other methods, not shown in FIG. 10.

If the message was from an active reader, the message is analyzed for its op code and content and the request is executed. A response is generated, if required.

If the message is from another transceiver, the following steps are performed. First, the message is analyzed for its op code and content and the request is executed. If the message is a request to relay a message to an active reader, then the transceiver sends messages and checks for any known active readers. If an active reader is found, then the message is relayed to the active reader. If no active reader is found, a message is sent to the transceiver of the fact. If the message is not a request to relay a message, then the request is performed and a response is generated and sent to the transceiver, if required.

It will be appreciated that in other embodiments, a message may be defined which requires that when that message is received by the transceiver from an active reader, another transceiver or an active tag, additional messages may be sent to other components (e.g. active readers, active tags, or other transceivers) in addition to, or instead of, the messages shown in the respective branches of FIG. 10.

In another embodiment, if the message was from an active tag the following steps are performed. First the message is analyzed for its op code and content. If the message is a request to relay a message to an active reader, then the transceiver sends messages and checks for any known active readers. If an active reader is found, then the message is relayed to the active reader. If no active reader is found, a message is sent to the active tag of the fact.

It will be appreciated that in other embodiments many variations of procedures, implementation and protocols as described above may be provided. For example, the transceivers may be able to receive messages from active tags and encode and forward messages to active tags. Also, the transmission frequencies for active and passive tag messages may be closer together. Also, the active readers may be able to receive messages from passive tags. Also, semi-passive tags may be considered to be active tags, for the purpose of identification to transceivers.

Although the present invention has been described by way of particular embodiments and examples thereof, it should be noted that it will be apparent to persons skilled in the art that modifications may be applied to the present particular embodiment without departing from the scope of the present invention.

We claim:

1. A system for relaying data from tags associated with inventory items, said system comprising:
a passive tag comprising first data associated with a first inventory item, a first
transmission module to transmit a first message containing said first data in a
passive tag frequency; and
a transceiver for receiving said first message, transferring said first data into a
second message and transmitting said second message as an active tag
message.

2. The system for relaying data from tags associated with inventory items as claimed in claim 1, further comprising:
an active tag associated with a second inventory item and comprising second
data associated with said second inventory item and a second transmission
module to transmit an active tag message;
an application server for storing and processing data associated with said
active tag and said passive tag; and
an active reader for receiving said active tag message from said transceiver
and for communicating said active tag message to said application server.

3. The system for relaying data from tags associated with inventory items as claimed in claim 2, wherein:
said transceiver periodically sends request messages to identify neighbouring
transceivers, tags and active readers.

4. The system for relaying data from tags associated with inventory items as claimed in claim 3, wherein:
if said transceiver cannot contact said active reader, said transceiver attempts
to identify a neighbouring transceiver having contact with said active reader and
then transmit said second message to said neighbouring transceiver.

5. The system for relaying data from tags associated with inventory items as claimed in claim 4, wherein:
said second message is a request to said neighbouring transceiver to forward
said second message to said active reader.

6. The system for relaying data from tags associated with inventory items as claimed in claim 5, wherein:
said transceiver stores said first data in a buffer and periodically transmits
stored data relating to received messages in active tag messages.

7. The system for relaying data from tags associated with inventory items as claimed in claim 6, wherein said transceiver comprises
a transmitter for active frequency communications;
a transmitter for passive frequency communications;
a microprocessor;
said buffer; and
a program operating on said microprocessor to control generation and
transmission of transmitted messages and receipt and analysis of received
messages.

8. A method for relaying data from tags associated with inventory items, said method comprising:
at a transceiver, receiving a first message from a passive tag in a passive tag
frequency containing first data associated with an inventory item; and
at said transceiver transferring said first data into a second message and
transmitting said second message to an active reader as an active tag
message.

9. The method for relaying data from tags associated with inventory items as claimed in claim 8, further comprising:
at said transceiver
storing said first data;
periodically transferring said first data into a second message; and
transmitting said second message as an active tag message.

10. The method for relaying data from tags associated with inventory items as claimed in claim 9, further comprising:
if said transceiver cannot contact said active reader, attempting to identify a
neighbouring transceiver having contact with said active reader and then
transmitting said second message to said neighbouring transceiver.

11. The method for relaying data from tags associated with inventory items as claimed in claim 10, further comprising:
requesting said neighbouring transceiver to forward said second message to
said active reader.

12. A system for tracking tags associated with inventory items, said system comprising:
a collection of active tags, each active tag in said collection comprising data
associated with an inventory item and a first transmission module to transmit a
first message containing said data;
a collection of passive tags, each passive tag in said collection comprising data
associated with another inventory item and a second transmission module to
transmit a second message containing said data;
a network of transceivers for reading passive tag messages from any passive
tag in said collection of passive tags and for broadcasting transceiver
messages containing data from said passive tag messages to an active reader;
an application server for storing and processing data associated with said
collections of active and passive tags; and
said active reader for receiving any of said first and transceiver messages,
extracting encoded data therefrom and providing said encoded data to said
application server.

13. The system for tracking tags associated with inventory items as claimed in claim 12 wherein, transceivers within said network of transceivers store data contained within received passive tag messages before broadcasting said transceiver messages.

14. The system for tracking tags associated with inventory items as claimed in claim 13, wherein a transceiver in said network of transceivers periodically sends request messages to identify neighbouring transceivers, tags and active readers.

15. The system for tracking tags associated with inventory items as claimed in claim 14, wherein if said transceiver cannot contact any active reader, said transceiver attempts to identify a neighbouring transceiver having contact with said active reader and then transmits any transceiver messages to said neighbouring transceiver.

16. The system for tracking tags associated with inventory items as claimed in claim 15, wherein
said neighbouring transceiver provides an acknowledgement message to said
transceiver upon receipt of said any transceiver messages; and
said transceiver clears its buffer of any data related to said any transceiver
messages upon receipt of said acknowledgement signal.

17. The system for tracking tags associated with inventory items as claimed in claim 16, further comprising
a second active reader also for receiving any of said first and transceiver
messages, extracting encoded data therefrom and providing said encoded data
to said application server, wherein
said active reader and said second active reader each periodically check whether it can contact said application server and if it cannot, it attempts to contact the other active reader to transmit any encoded data to said application server.
